(19) United States
(12) Patent Application Publication
(10) Pub. No.: US 2014/0038165 A1
(43) Pub. Date: Feb. 6, 2014

(54) PARALLELEPIPED TO TEACH TO CORRELATE A DISTINCTIVE SIGN OF A PERSONAGE TO THE RELATED PERSONAGE

(71) Applicant: Azra Jamous, Milan (IT)

(72) Inventor: Azra Jamous, Milan (IT)

(73) Assignee: SUK S.r.l., Milan (IT)

(21) Appl. No.: 13/567,530

(22) Filed: Aug. 6, 2012

(51) Int. Cl. G09B 19/00

(52) U.S. Cl. CPC G09B 19/00
USPC 434/430

(57) ABSTRACT

The present invention concerns a parallelepiped to train to correlate the distinctive sign of a personality to its personality.

### OBJECT OF THE INVENTION

The present invention concerns a parallelepiped to train to correlate the distinctive sign of a personality to its respective personality. For instance, the forefinger and the middle finger of a hand forming the letter “V” for victory and the historical personality Sir Winston Churchill.

### PRIOR ART

The methods known to teach to correlate a distinctive sign of a personality to its respective personality are mainly visual. They are mainly realized by using graphical representations. Said graphical representations are photos, motion picture or a direct contact.

The teaching by images places the subjects in a passive position and such a passivity makes the learning less easy.

It has been experimentally verified that people learns certain notions more easily through a physical gesture.

One of the tools used for learning through a physical gesture is the parallelepiped. However, the parallelepipeds known are used as an educational tool to stimulate the mind of people in order to compose or re-compose figures, sentences, sequences of numbers. Said parallelepipeds known stimulate the mnemonic faculties of people, not the correlation ones.

Applicant calls as prior art of the parallelepiped used as teaching instruments the Chinese patent no. CN201725461U published on Mar. 16, 2011; the German patent no. DE102008003002 (A1) published on Jul. 9, 2009.

### DISCLOSURE OF THE INVENTION

The limits of the parallelepiped as an educational tool are overcome by the present invention. Said invention uses said solid as an educational tool suitable for developing the mnemonic faculties of people, but in particular it teaches o correlate at least two specific elements having a common source, specifically the distinctive sign of a personality to its respective personality.

The personalities object of the present invention can belong to different categories. For instance, they are historical personalities, political personalities, sports personalities, musical personalities, or fictional characters.

The distinctive signs object of correlation can be of different categories. For instance, the sign might be a famous gesture of the personality or a date that the personality is related to, a famous sentence of that personality or even his signature.

As example, the Applicant emphasizes the above mentioned example concerning the historical personality Sir Winston Churchill and the fingers of the hand forming a “V” for victory.

As described above, the parallelepiped object of this invention is suitable to teach to correlate at least two elements having a common source, specifically the distinctive sign of a personality to its respective personality. It comprises at least one first face having the distinctive sign that is the object of the correlation on the outer surface and the graphical representation of the personality that is the object of said correlation on the inner surface.

Should the purpose of the parallelepiped be to correlate a specific sports personality to the number of his team shirt, his distinctive sign, in this case the number of his team shirt would be put on the outer surface of the first face, whereas the graphical representation or a photo of that sports personality would be put on the inner surface thereof.

Should the purpose of a parallelepiped be that to correlate a historical personality to one of his symbolic gestures, the distinctive sign of that personality, in this case shall be placed the symbolic gesture of that personality on the outer surface of the first face and on the inner surface of the first face shall be placed a graphical representation or a photo of that historical personality. In the above mentioned example relevant to Sir Winston Churchill, the fingers of the hand forming the letter “V” would be put on the outer surface of the first face and a graphical representation or a photo of Sir Winston Churchill shall be put on the inner surface of the first face.

As already said above, in order to teach to a person to correlate a distinctive sign of a personality to its respective personality, it is preferable that the person performs a physical gesture in such a way that the distinctive sign shall be printed on a surface and during this activity the person can see the image of the personality to whom the distinctive sign refers to.

Experimental observations demonstrated that a person printing a distinctive sign of a personality on a surface and simultaneously sees the graphical representation of that personality it is easier to correlate the distinctive sign of that personality to its respective personality.

In order to make it easier to print a distinctive sign on a surface, the distinctive sign is a stamp, preferably an ink stamp.

The distinctive sign to be correlated to a personality might even not be represented graphically, but it might be one or several sounds. In this case, the gesture of printing the distinctive sign on a surface obtains as result one or several sounds coming from a device located inside the parallelepiped.

A better teaching is obtained by the parallelepiped having a second and a third transparent faces and at least a fourth and fifth faces on which at least one graphical representation of the personality is put.

In order to improve the visualization of the images of the personality to correlate with the distinctive sign, the second and third transparent faces are adjacent and at least one graphical image of the personality is put on the inner surface of the fourth face preferably taken in peculiar or symbolic events or situations.

The parallelepiped objects of this invention can have the second, third, fourth, and fifth faces which are orthogonal to the first face to facilitate the view of the graphical representations of the personality.

In order to protect the distinctive sign placed on the outer surface of the first face, the parallelepiped object of the present invention is filled out with a coverplate having means to connect said coverplate to the parallelepiped.

### DESCRIPTION OF THE FIGURES

FIGS. 1-4 show perspective views of the whole parallelepiped that is the object of this invention.

In order to better describe and explain the invention, the Applicant used the mentioned example of the distinctive sign of the fingers forming the letter “V” for victory and its respective personality, Sir Winston Churchill, for the figures of the present document.

FIG. 1 shows a perspective view of the parallelepiped (1) to teach to correlate the distinctive sign (2) of a personality to its respective personality (3), shown in FIG. 2.

Said FIG. 1 shows the mentioned parallelepiped (1) with a first face (4) having the outer surface (4¹) where the distinctive sign (2) is put; a second face (5) and a third face (6) which are transparent. Said distinctive sign (2) is a stamp, preferably an ink stamp or one or several sounds coming from a device located inside the parallelepiped (1) or a stamp and one or several sounds.

FIG. 3 shows the inner surface (4²) of the first face (4) on which a graphical representation of the personality (3) is put. In the example used by the Applicant to explain the invention shown in the drawings, the inner surface (4²) of the first face (4) is represented by the image of Sir Winston Churchill face.

Said FIG. 3 also shows a fourth face (7) and a fifth face (8). FIG. 3 shows a preferred example in which the graphical representation of the personality (3) is put on the inner surface of said faces. Said graphical representations might also be put on the outer surfaces of one or both said faces.

FIG. 4 shows the inner surface (7¹) of the fourth face (7) on which a symbolic graphical representation of the personality (2) is put. In the example used by the Applicant to explain the invention by the drawings, the symbolic graphical representation of the inner surface (7¹) of the fourth face (7) is the image of the Sir Winston Churchill's face having the Union Jack as a background. Said FIG. 4 also shows a coverplate (9) possibly placed onto the outer surface (4¹) of the first face (4) to protect said outer surface (4¹) of the first face (4). Said coverplate (9) has means (10) to connect said coverplate (9) to the parallelepiped (1), in particular to prevent said coverplate (9) can be lost.

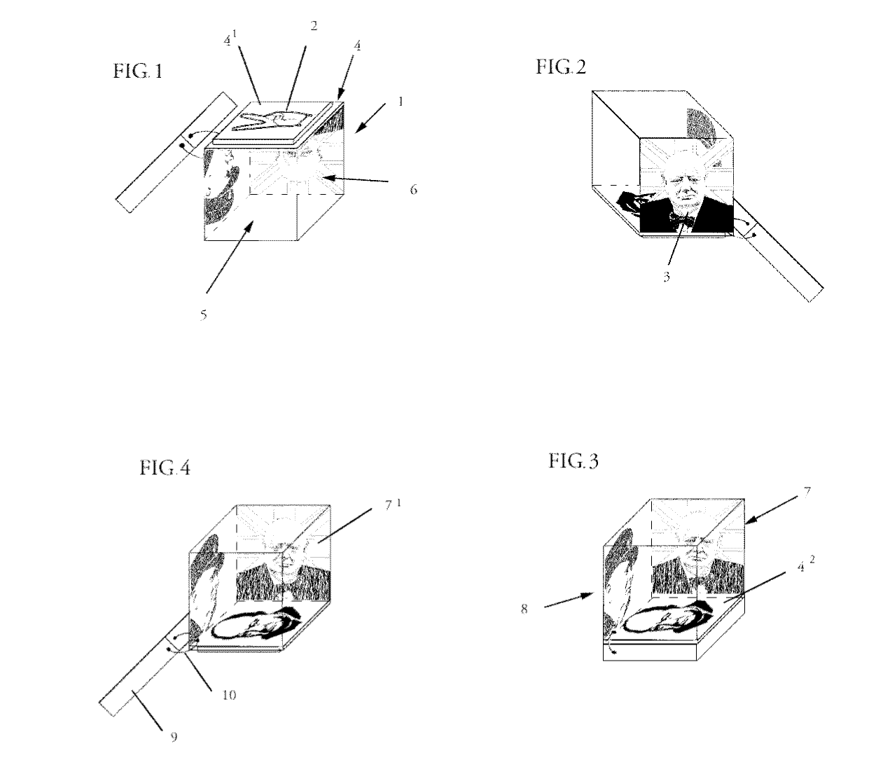

FIGS. 1-4 show the second face (5), the third face (6), the forth face (7), and the fifth face (8) arranged orthogonally to the first face (4).

What it is claimed:

1. A parallelepiped to teach to correlate the distinctive sign of a personality to its respective personality, comprising:
a first face having an outer surface on which the distinctive sign is put;
a graphical representation of the personality put on the inner surface of said first face;
at least a second face and a third face that are transparent;
at least a fourth face and a fifth face on which at least one graphical representation of the personality is put on at least one surface of said faces.

2. A parallelepiped to teach to correlate the distinctive sign of a personality to its respective personality according to claim 1 wherein the distinctive sign put on the outer surface of the first face is a stamp.

3. A parallelepiped to teach to correlate the distinctive sign of a personality to its respective personality according to claim 1 wherein the second and third faces are transparent and adjacent.

4. A parallelepiped to teach to correlate the distinctive sign of a personality to its respective personality according to claim 1 wherein a symbolic graphical representation of the personality is put on the inner surface of the fourth face.

5. A parallelepiped to teach to correlate the distinctive sign of a personality to its respective personality according to claim 1 wherein the second face, the third face, the fourth face and the fifth face are orthogonal to the first face.

6. A parallelepiped to teach to correlate the distinctive sign of a personality to its respective personality according to claim 1 wherein said distinctive sign is one or several sounds coming from a device located inside the parallelepiped.

7. A parallelepiped to teach to correlate the distinctive sign of a personality to its respective personality according to claim 1 wherein it comprises a coverplate to be located onto the external surface of the first face.

8. A parallelepiped to teach to correlate the distinctive sign of a personality to its respective personality according to claim 7 wherein said cover plate has means to be connected to the parallelepiped.
